(19) United States
(12) Patent Application Publication
(10) Pub. No.: US 2005/0228657 A1
(43) Pub. Date: Oct. 13, 2005

(54) Joint classification for natural language call routing in a communication system

(76) Inventors: Wu Chou, Basking Ridge, NJ (US); Li Li, Bridgewater, NJ (US); Feng Liu, Raritan, NJ (US)

Correspondence Address: Ryan, Mason & Lewis, LLP, 90 Forest Avenue, Locust Valley, NY, 11560, US

(21) Appl. No.: 10/814,081

(22) Filed: Mar. 31, 2004

(51) Int. Cl. G10L 19/14

(52) U.S. Cl. 704/225

(57) ABSTRACT

Joint classification functionality is provided for natural language call routing (NLCR) or other type of natural language processing (NLP) application implemented in a communication system switch or other processor-based device. The processor-based device is configured to identify a plurality of words contained within a given communication, and to process the plurality of words utilizing a joint classifier. The joint classifier determines at least one category for the plurality of words based on application of a combination of word information and word class information to the plurality of words. Words and word classes utilized to provide the respective word information and word class information for use in the joint classifier may be selected using information gain based term selection.

### FIELD OF THE INVENTION

The invention relates generally to the field of communication systems, and more particularly to language-based routing or other language-based techniques for processing calls or other communications in such systems.

### BACKGROUND OF THE INVENTION

An approach known as natural language call routing (NLCR) may be used in a communication system switch to route incoming calls or other communications to appropriate destinations. NLCR in the context of processing an incoming call generally utilizes a natural language based dialogue interaction to determine the intention of the caller and to route the call in a manner consistent with that intention. It thus attempts to provide improved service quality relative to standard interactive voice response (IVR) approaches, which are traditionally implemented using highly constrained finite-state grammars derived from a service manual or other predetermined call processing script.

NLCR is related to other natural language processing (NLP) applications, such as natural language understanding (NLU) and information retrieval. It is well known in these applications that literal matching of word terms in a user query to a particular destination description can be problematic. This is because there are many ways to express a given concept, and the literal terms in a query may not match those of a relevant document or other destination description. Certain natural language understanding and information retrieval techniques have been applied in NLCR, including latent semantic indexing (LSI). See, for example, S. Deerwester et al.,“Indexing by Latent Semantic Analysis,” Journal of the American Society for Information Science, 41:391-407, 1990, J. Chu-Carrol et al.,“Vector-Based Natural Language Call Routing,” Computational Linguistics, 25(3):361-389, 1999, and L. Li et al.,“Improving Latent Semantics Indexing Based Classifier with Information Gain,” Proc. of the 7th International Conference on Spoken Language Processing, 2:1141-1144, September 2002, all of which are incorporated by reference herein.

NLP generally involves forming word term classes by clustering word terms that have some common properties or similar semantic meanings. Such word term classes are also referred to herein as“word classes,” “clusters” or“classes.” They are typically regarded as more robust than word terms, because the word class generation process can be viewed as providing a mapping from a surface form representation in word terms to broader generic concepts that should be more stable. One problem associated with the use of word classes is that they may not be detailed enough to differentiate confusion cases in various NLP tasks. Also, it may be difficult to apply word classes in certain situations, since not all word classes are robust, especially when speech recognition is involved. In addition, most word class generation is based on linguistic information or task dependent semantic analysis, both of which may involve manual intervention, a costly, error prone and labor-intensive process.

Accordingly, a need exists for improved techniques providing more efficient and effective utilization of word classes for NLCR, NLU and other NLP applications.

### SUMMARY OF THE INVENTION

The present invention meets the above-noted need by providing, in accordance with one aspect of the invention, joint classification techniques suitable for use in implementing NLCR, NLU or other NLP applications in a communication system.

A communication system switch or other processor-based device is configured to identify a plurality of words contained within a given communication, and to process the plurality of words utilizing a joint classifier. The joint classifier determines at least one category for the plurality of words based on application of a combination of word information and word class information to the plurality of words. Words and word classes utilized to provide the respective word information and word class information for use in the joint classifier may be selected using information gain based term selection.

In the illustrative embodiment, the joint classifier is implemented in an NLCR element of a communication system switch. The NLCR element of the switch is operative to route the communication to a particular one of a plurality of destination terminals of the system based on a category determined by the joint classifier.

The combination of word information and word class information utilized by the joint classifier may comprise at least one term-category matrix characterizing words and word classes selected using the information gain based term selection. A given cell i, j of the term-category matrix comprises information indicative of a relationship involving the i-th selected term and the j-th category, where a term may be a word or a word class.

In accordance with another aspect of the invention, the information gain based term selection calculates information gain values for each of a plurality of terms, sorts the terms by their information gain values in a descending order, sets a threshold as the information gain value corresponding to a specified percentile, and selects the terms having an information gain value greater than or equal to the threshold. The selected terms may then be processed to form a term-category matrix utilizable by the joint classifier in determining one or more categories for the plurality of words of the given communication.

The present invention in the illustrative embodiment provides numerous advantages over the conventional techniques described above. For example, the word class generation process can be made entirely automatic, thereby avoiding the above-noted problems associated with use of linguistic information or task dependent semantic analysis. The joint classification process, through information gain based selection of words and classes, avoids the performance problems typically associated with automatic generation of word classes, and in fact provides significantly improved performance relative to conventional techniques that use either word information alone or word class information alone.

### BRIEF DESCRIPTION OF THE DRAWINGS

FIG. 1 shows an exemplary communication system in which the invention is implemented.

FIG. 2 is a diagram of a joint classification process implementable in the FIG. 1 system in accordance with the invention.

FIG. 3 shows an automatic clustering algorithm utilizable in conjunction with the present invention.

FIG. 4 shows a flow diagram and a simple example illustrating automatic clustering using an algorithm of the type shown in FIG. 3.

FIG. 5 illustrates a number of exemplary techniques for combining of word information and word class information for use in a joint classifier in accordance with the invention.

FIG. 6 shows the steps of an information gain based term selection process utilizable in determining word information and word class information for use in a joint classifier in accordance with the invention.

FIG. 7 shows another example of a communication system in which the invention is implemented.

### DETAILED DESCRIPTION OF THE INVENTION

The invention will be described below in conjunction with an exemplary communication system implementing a NLCR application. It should be understood, however, that the invention is not limited to use with any particular type of communication system or any particular configuration of switches, networks, terminals, classifiers, routers or other processing elements of the system. Those skilled in the art will recognize that the disclosed techniques may be used in any communication system in which it is desirable to provide improved implementation of NLCR, NLU or other NLP application.

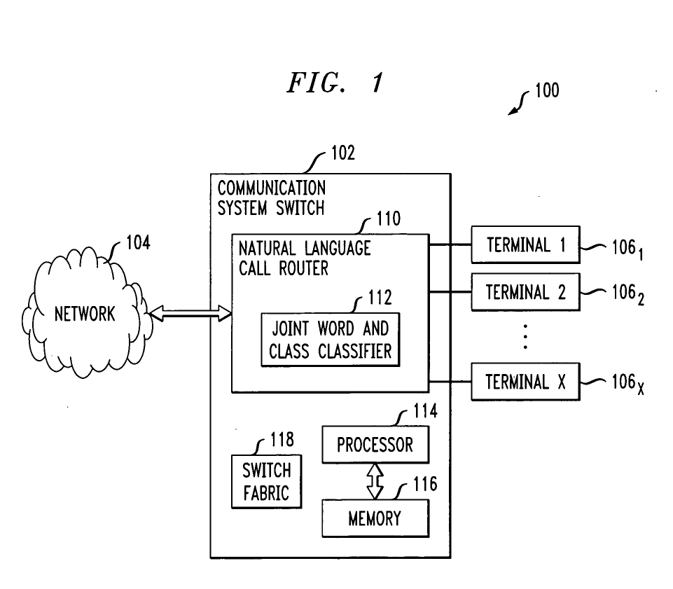

FIG. 1 shows an example communication system 100 in which the present invention is implemented. The system 100 includes a switch 102 coupled between a network 104 and a plurality of terminals 106₁, 106₂, . . . 106_{X}.

The switch 102 includes an NLCR element 110 comprising a joint classifier 112. As will be described in greater detail below, the joint classifier 112 utilizes a joint classification technique, based on both word terms and word term classes, to classify natural language speech received via one or more incoming calls or other communications from the network 104. The word terms and word term classes are generally referred to herein as words and classes, respectively.

Although not shown in the figure, conventional speech recognition functions may be implemented in or otherwise associated with the joint classifier 112 or the NLCR 110. Such speech recognition functions may, for example, convert speech signals from incoming calls or other communications into words or classes suitable for processing by the joint classifier 112. The joint classifier 112 may additionally or alternatively operate directly on received speech signals, or on words or classes derived from other types of signals, such as text, data, audio, video or multimedia signals, or on various combinations thereof. The invention is not limited with regard to the particular signal or information processing capabilities that may be implemented in the joint classifier 112, NLCR element 110 or associated system elements.

The switch 102 as shown further includes a processor 114, a memory 116 and a switch fabric 118. Although these elements are shown as being separate from the NLCR element 110 in the figure, this is for simplicity and clarity of illustration only. For example, at least a portion of the NLCR, such as the joint classifier 112, may be implemented in whole or in part in the form of one or more software programs stored in the memory 116 and executed by the processor 114. Also, certain switch functions commonly associated with the processor 114, memory 116 or switch fabric 118, or other element of switch 102, may be viewed as being implemented at least in part in the NLCR element 110, and vice-versa.

The switch 102 may comprise an otherwise conventional communication system switch, suitably modified in the manner described herein to implement NLCR, or another type of NLP application, based on joint classification using both words and classes. For example, the switch 102 may comprise a DEFINITY® Enterprise Communication Service (ECS) communication system switch from Avaya Inc. of Basking Ridge, N.J., USA. Another example switch suitable for use in conjunction with the present invention is the MultiVantage™ communication system switch, also from Avaya Inc.

Network 104 may represent, e.g., a public switched telephone network (PSTN), a global communication network such as the Internet, an intranet, a wide area network, a metropolitan area network, a local area network, a wireless cellular network, or a satellite network, as well as portions or combinations of these and other wired or wireless communication networks.

The terminals 106 may represent wired or mobile telephones, computers, workstations, servers, personal digital assistants (PDAs), or any other types of processor-based terminal devices suitably configured for interaction with the switch 102, in any combination.

Additional elements, of a type known in the art but not explicitly shown in FIG. 1, may be included in or otherwise associated with one or more of the classifier 112, NLCR element 110, switch 102 or system 100, in accordance with conventional practice. It is to be appreciated, therefore, that the invention does not require any particular grouping of elements within the system 100, and numerous alternative configurations suitable for providing the joint classification functionality described herein will be readily apparent to those skilled in the art.

In operation, the NLCR element 110 processes an incoming call or other communication received in the switch 102 in order to determine an appropriate category for the call, and routes the call to a corresponding one of the destination terminals 106 based on the determined category. A sequence or other arrangement of words is identified in the communication, and the words are processed utilizing joint classifier 112. The joint classifier is configured to determine at least one category for the words, by applying a combination of word information and word class information to the words.

A“category” as the term is used herein in the context of the illustrative embodiment may comprise any representation of a suitable destination for a given communication, although other types of categories may be used in other embodiments. The invention is not restricted to use with any particular type of categories, and is more generally suitable for use with any categories into which sets of words in communications may be classified by a joint classifier.

The term“word” as used herein is intended to include, by way of example and without limitation, a signal representative of a portion of a speech utterance.

The illustrative embodiment utilizes an automatic word class clustering algorithm to generate word classes from a training corpus, and information gain (IG) based term selection to combine word information and word class information for use by the joint classifier. Advantageously, this approach provides a significant improvement over conventional arrangements based on word information only or word class information only.

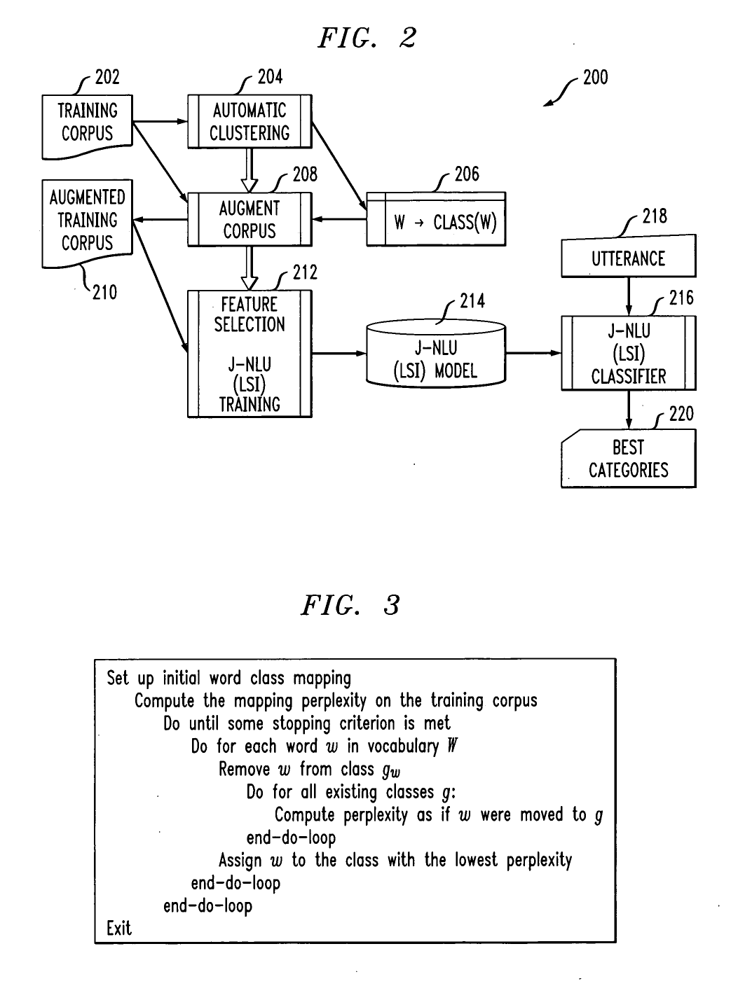

FIG. 2 shows an example of one possible joint classification process 200 implementable in the FIG. 1 system in accordance with the invention. An automatic clustering process 204 utilizes word information from a training corpus 202, and implements a mapping operation 206 of words to word classes. An augment corpus operation 208 utilizes the results of the automatic clustering process 204 and its associated mapping 206 to generate an augmented training corpus 210 which is utilized in a feature selection process 212. The feature selection process 212 preferably utilizes the above-noted IG-based term selection, where a“term” in this context may comprise a word or a word class.

In this example, the feature selection process is more particularly referred to as a joint natural language understanding (J-NLU) LSI training process, where, as previously noted herein, LSI denotes latent semantic indexing. It should be understood, however, that the present invention does not require the use of LSI or any other particular NLU or NLP technique.

The feature selection process 212 results in a J-NLU (LSI) model 214, which is utilized in a J-NLU (LSI) classifier 216, and includes a combination of word information and word class information. The joint classifier 216, which may be viewed as an exemplary implementation of the joint classifier 112 of FIG. 1, processes an utterance 218 comprising a plurality of words to identify one or more appropriate categories for the words. The joint classifier 216 in this particular example generates a set of one or more best categories 220 for the utterance 218.

It should be noted that the training aspects of a joint classification process such as that shown in FIG. 2 need not be implemented on the same processing platform as the joint classifier itself. For example, in the context of the communication system of FIG. 1, training may be accomplished externally to system 100, using an otherwise unrelated device or system, with the resulting model being downloaded into or otherwise supplied to the joint classifier 112.

Referring now to FIG. 3, an automatic clustering algorithm utilizable in the automatic clustering process 204 is shown. The clustering algorithm is an exchange algorithm of the type described in S. Martin et al.,“Algorithms for bigram and trigram word clustering,” Speech Communication 24(1998) 19-37, which is incorporated by reference herein. As indicated above, the clustering algorithm is used to automatically generate word classes for use in the joint classifier 112 of NLCR element 110.

Given a vocabulary W, the algorithm partitions the words of the vocabulary into a fixed number of word classes. The algorithm attempts to find a class mapping function G:w→g_{w}, which maps each word term w to its word class g_{w} such that the perplexity of an associated class-based language model is minimized on the training corpus. The algorithm employs a technique of local optimization by looping through each word in the vocabulary, moving it tentatively to each of the word classes, searching for the class membership assignment that gives the lowest perplexity. The process is repeated until a stopping criterion is met.

As described in the above-cited S. Martin et al. reference, the perplexity (PP) of the class-based language model can be calculated as follows:
PP=2^{LP},
where LP can be estimated as

$$LP = \frac{- 1}{T} [ {\sum }_{w} N ( w ) log N ( w ) + {\sum }_{{g}_{w ,} {g}_{v}} N ( {g}_{w} , {g}_{v} ) log \frac{N ( {g}_{w} , {g}_{v} )}{N ( {g}_{w} ) N ( {g}_{v} )} ] ,$$

where T is the length of a training text, and N(·) is the number of occurrences in the training corpus of an event given in the parentheses.

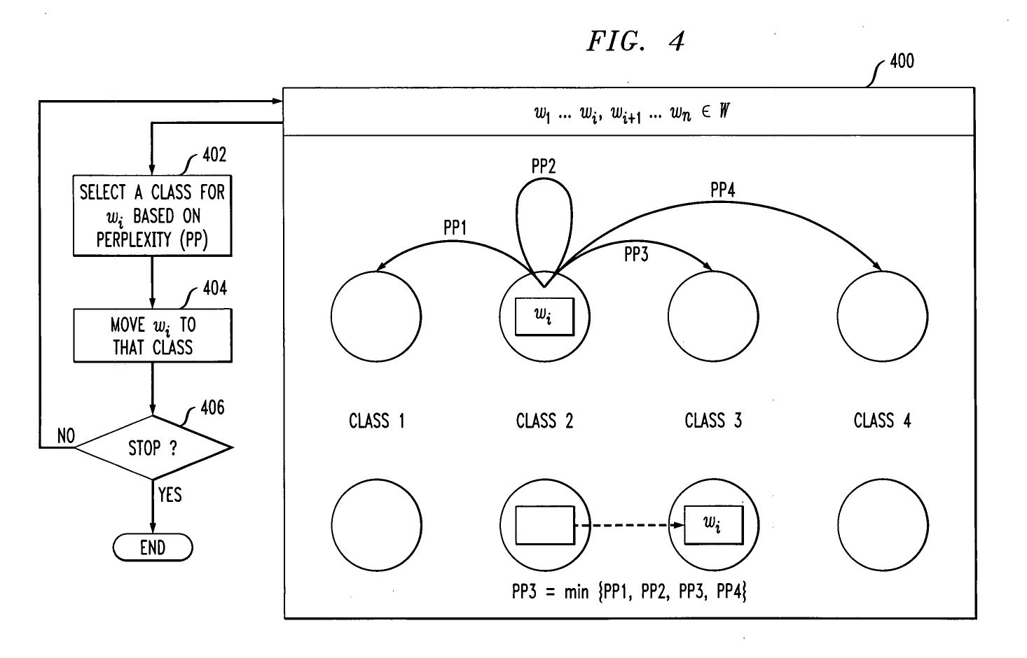

FIG. 4 shows a flow diagram and a simple example illustrating automatic clustering using an algorithm of the type shown in FIG. 3. As shown generally at 400, a vocabulary W includes words w₁, w₂, . . . wᵢ, wᵢ₊₁, . . . wₙ. These words are processed as indicated at steps 402, 404 and 406. Generally, step 402 selects a class for a given word wᵢ based on the perplexity, and step 404 moves the word to that class. Step 406 determines if the stopping criterion has been satisfied. The example shows four classes, denoted Class 1, Class 2, Class 3 and Class 4, and illustrates the movement of word wᵢ from Class 2 to Class 3 upon the determination that perplexity value PP3 is the minimum perplexity value in the set of perplexity values {PP1, PP2, PP3, PP4}.

It is to be appreciated that the particular automatic clustering algorithm described in conjunction with FIGS. 3 and 4 is presented by way of example only. The invention can be implemented using other types of clustering algorithms, or other techniques for determining word classes.

A significant drawback of an automatic clustering algorithm such as that described above is that it can generate word classes that are not sufficiently useful or robust for NLCR, NLU or other NLP applications. This problem is overcome in the illustrative embodiment through the use of the above-noted IG-based selection process, which selects words and word classes that are particularly well suited for NLCR, NLU or other NLP applications. By combining the resulting selected word information and word class information, the robustness and performance of the corresponding classifier is considerably improved.

The IG-based term selection process will now be described in greater detail. Generally, the IG-based term selection process provides an information theoretic framework for selection of words and classes. An IG value of a given term may be viewed as the degree of certainty gained about which category is“transmitted” when the term is“received” or not“received.” The significance of the term is determined by the average entropy variations on the categories, which relates to the perplexity of the classification task.

More specifically, the IG value of a given term tᵢ, IG(tᵢ), may be calculated using the following equations:

$$\begin{matrix}IG ( {t}_{i} ) = H ( C ) - H ( C \vert {t}_{i} ) - H ( C \vert {\overline{t}}_{i} ) & ( 1 ) \\ H ( C ) = - {\sum }_{j = 1}^{n} p ( {c}_{j} ) log ( p ( {c}_{j} ) ) & ( 2 ) \\ H ( C \vert {t}_{i} ) = - p ( {t}_{i} ) {\sum }_{j = 1}^{n} p ( {c}_{j} \vert {t}_{i} ) log ( p ( {c}_{j} \vert {t}_{i} ) ) & ( 3 ) \\ H ( C \vert {\overline{t}}_{i} ) = - p ( {\overline{t}}_{i} ) {\sum }_{j = 1}^{n} p ( {c}_{j} \vert {\overline{t}}_{i} ) log ( p ( {c}_{j} \vert {\overline{t}}_{i} ) ) & ( 4 )\end{matrix}$$

where n is the number of categories, and

H(C): the entropy of the categories

H(C|tᵢ): the conditional category entropy when tᵢ is present

H(C|\overline{t}ᵢ): the conditional entropy when tᵢ is absent

p(cⱼ): the probability of category cⱼ

p(cⱼ|tᵢ): the probability of category cⱼ given tᵢ

p(cⱼ|\overline{t}ᵢ): the probability of cⱼ without tᵢ.

The right side of Equation (1) can be transformed to the following:

$${\sum }_{j = 1}^{n} [ \begin{matrix}p ( {t}_{i} {c}_{j} ) log ( \frac{p ( {t}_{i} {c}_{j} )}{p ( {c}_{j} ) p ( {t}_{i} )} ) + \\ ( p ( {c}_{j} ) - p ( {t}_{i} {c}_{j} ) ) log ( \frac{p ( {c}_{j} ) - p ( {t}_{i} {c}_{j} )}{p ( {c}_{j} ) ( 1 - p ( {t}_{i} ) )} )\end{matrix} ]$$

where

p(tᵢ): the probability of term tᵢ

p(tᵢcⱼ): the joint probability of tᵢ and cⱼ.

Additional details regarding IG-based word selection can be found in the above-cited L. Li et al. reference entitled“Improving Latent Semantics Indexing Based Classifier with Information Gain.”

As noted above, the present invention provides a joint classifier that uses a combination of word information and word class information, with the particular words and the particular classes being selected using an IG-based approach.

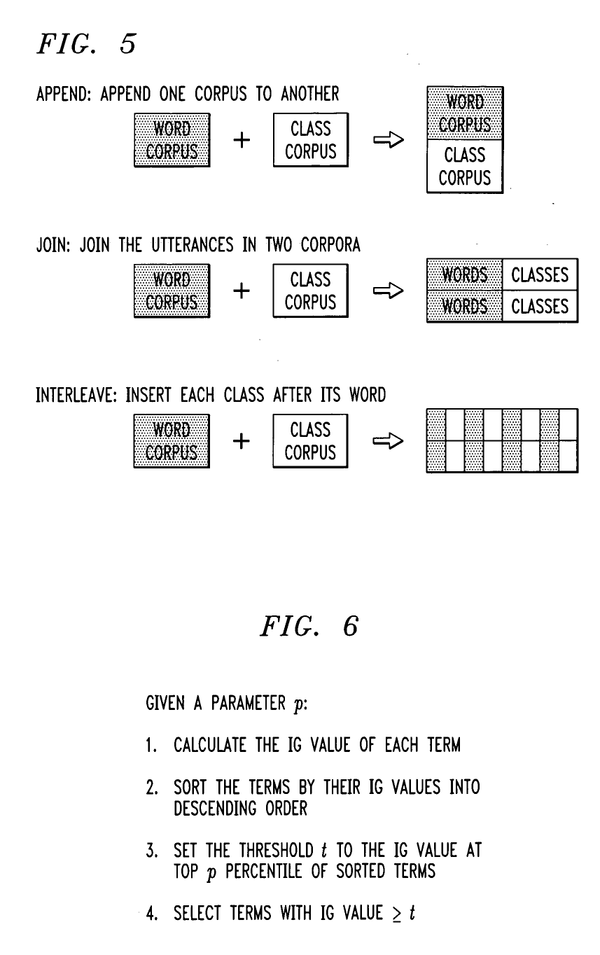

FIG. 5 illustrates a number of exemplary techniques for combining of word information and word class information for use in a joint classifier such as joint classifier 112 or joint classifier 216. Generally, the figure shows three different techniques for combining word information and word class information.

The first of these techniques is an append technique, in which a word corpus and a class corpus are combined by appending the class corpus to the word corpus.

The second technique is a join technique, in which different utterances each comprising multiple words are joined with their corresponding sets of classes.

Finally, the third technique is an interleave technique, in which individual words are interleaved with their corresponding classes.

These combination techniques should be viewed as exemplary only, and other techniques may be used to combine word information with word class information for use in a joint classifier in accordance with the invention.

The combination techniques shown in FIG. 5 may be utilized in generating the augmented training corpus 210 of FIG. 2. An IG-based term selection process may then be applied to the augmented training corpus 210, in order to generate a set of terms for use in a term-category matrix, as will be explained in greater detail below.

FIG. 6 shows the steps of an exemplary IG-based term selection process utilizable in determining word information and word class information for use in the joint classifier.

A term-category matrix M may be formed using terms from IG-based joint term selection. A given term may be a word or a word class, depending on the IG value which describes the discriminative information of the term in an NLCR task. The M [i,j] cell of the term-category matrix includes information indicative of a relationship involving the i-th selected term and the j-th category. An m×k term matrix T and a n×k category matrix C are derived by decomposing M through a singular value decomposition (SVD) process, such that row T[i] is the term vector for the i-th term, and row C[i] is the category vector for the i-th category, as is typical in a conventional LSI based approach.

The information specified in the term-category matrix is generally determined by the type of classifier used. For example, if an LSI type classifier is used, the information in the M [i,j] cell of the term-category matrix is typically the term frequency-inverse document frequency weighting of the i-th term in the j-th category. The joint word and word class classifier 112 in the illustrative embodiment does not require the use of any particular classifier type, and thus the information in the M [ij] cell of the term-category matrix is more generally referred to herein as being indicative of a relationship involving the i-th term and the j-th category.

The process shown in FIG. 6 is used to select terms for use in the term-category matrix, based on their discriminative power according to IG criterion given the joint information of both words and word classes. Again, a given“term” in this context may be a word or a word class. The process includes steps 1 through 4 as shown, and is initiated based on a percentile parameters. In step 1, the IG value of each relevant term is calculated, using the techniques described previously. Step 2 then sorts the terms by their IG values in a descending order. A threshold t is set to the IG value at the top p percentile of sorted terms in step 3. A normal IG threshold operating range may be based on percentile parameter p values of about 1% to 40%, although other values could be used, and the particular value or values used will depend upon the application. Finally, the terms with an IG value greater than or equal to the threshold t are selected in step 4. The selected terms may then be used to construct the term-category matrix, and an otherwise conventional LSI analysis can be performed. For example, to categorize an unknown utterance or other user input, the user input may be processed into a sequence of words. A query vector Q may be formulated according to the order and mapping from the word sequence to each of the selected terms in a joint word and word class LSI classifier. If both word w and its word class g_{w} are selected by the IG-based term selection process, both entries in the query vector will have non-zero term counts.

It should be noted that a joint LSI classifier or other joint classifier in accordance with the invention may be configured to utilize more than one word-class mapping, and additional term resources beyond words and classes.

Advantageously, a joint classifier in accordance with the invention is suitable for use in a variety of applications. The word class generation process can be made entirely automatic, thereby avoiding the above-noted problems associated with use of linguistic information or task dependent semantic analysis. The joint classification process, through IG-based selection of words and classes, avoids the performance problems typically associated with automatic generation of word classes, and in fact provides significantly improved performance relative to conventional techniques using either word information or word class information alone. For example, experimental results using a joint LSI classifier configured in the manner described herein indicate an average error reduction of approximately 10% to 15% over baseline word-only and class-only approaches, and over a variety of training and testing conditions. Additional details regarding these experimental results can be found in L. Li et al.,“An Information Theoretic Approach for Using Word Cluster Information in Natural Language Call Routing,” Proceedings of EuroSpeech '03, pp. 2829-2832, September 2003, which is incorporated by reference herein.

As previously noted, one or more of the processing functions described above in conjunction with the illustrative embodiments of the invention may be implemented in whole or in part in software utilizing processor 114 and memory 116 of switch 102. Other suitable arrangements of hardware, firmware or software, in any combination, may be used to implement the techniques of the invention.

It should again be emphasized that the above-described arrangements are illustrative only. For example, as indicated previously, a joint classifier in accordance with the invention can be implemented in a processor-based device other than a switch, such as a server, computer, wired or mobile telephone, PDA, etc. Alternative embodiments may utilize different system elements, different techniques for combining word information and word class information for use in the joint classifier, and different switch or other device configurations than those of the illustrative embodiments.

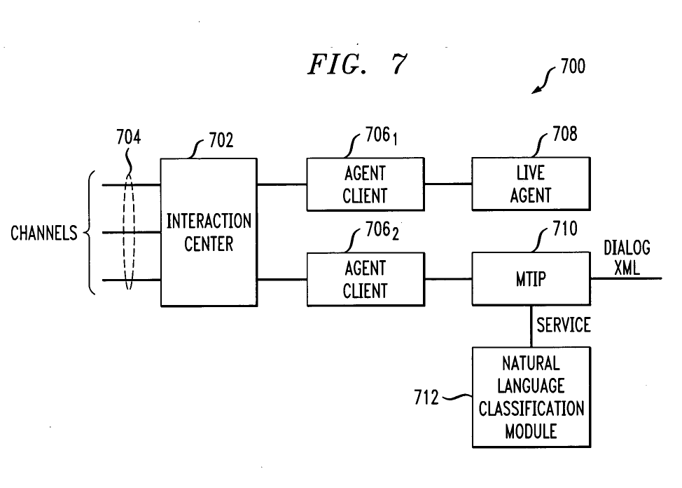

FIG. 7 shows an example of one such alternative embodiment. In this embodiment, a communication system 700 comprises an interaction center (IC) 702, which processes communications received over a number of channels 704. The system includes agent client terminals 706, and 7062, the former being coupled to a live agent 708, the latter being coupled to a multimodal technology integration platform (MTIP) 710 which implements an automated agent. The automated agent implemented on MTIP 710 can be encoded using a dialogue mark-up language, such as dialogue XML. The MTIP 710 interacts with natural language classification module 712 to determine an appropriate classification for words contained within particular received communications, utilizing the techniques of the present invention.

These and numerous other alternative embodiments within the scope of the following claims will be apparent to those skilled in the art.

1. A method of processing a communication in a communication system, the method comprising the steps of:
identifying a plurality of words contained within the communication; and
processing the plurality of words utilizing a joint classifier configured to determine at least one category for the plurality of words based on application of a combination of word information and word class information to the plurality of words.

2. The method of claim 1 wherein the joint classifier is implemented at least in part in a processor-based device of the communication system.

3. The method of claim 2 wherein a natural language call routing element of the switch routes the communication to a particular one of a plurality of destination terminals of the system based on the determined category.

4. The method of claim 1 wherein an automatic word class clustering algorithm is utilized to generate the word classes from at least one training corpus.

5. The method of claim 1 wherein one or more of the words and word classes utilized to provide the respective word information and word class information are selected using information gain based term selection.

6. The method of claim 5 wherein the information gain based term selection determines an information gain value for each of a plurality of terms, each of the terms comprising a word or a word class, the information gain value being indicative of entropy variations over a plurality of possible categories, and being determined as a function of a perplexity computation for an associated classification task.

7. The method of claim 1 wherein the combination of word information and word class information is generating by appending a class corpus to a word corpus.

8. The method of claim 1 wherein the combination of word information and word class information is generated by joining sets of multiple words with corresponding sets of word classes.

9. The method of claim 1 wherein the combination of word information and word class information is generated by interleaving individual words with their corresponding word classes.

10. The method of claim 1 wherein the combination of word information and word class information comprises at least one term-category matrix characterizing words and word classes selected using information gain based term selection.

11. The method of claim 10 wherein a cell i, j of the term-category matrix comprises information indicative of a relationship involving an i-th selected term and a j-th category.

12. The method of claim 5 wherein the information gain based term selection calculates information gain values for each of a plurality of terms, a given one of the terms comprising a word or a word class, sorts the terms by their information gain values in a descending order, sets a threshold as the information gain value corresponding to a specified percentile, and selects the terms having an information gain value greater than or equal to the threshold.

13. The method of claim 12 wherein the selected terms are processed to form a term-category matrix utilizable by the joint classifier in determining one or more categories for the plurality of words.

14. The method of claim 1 wherein the joint classifier comprises a joint latent semantic indexing classifier.

15. An apparatus for processing a communication in a communication system, the apparatus comprising:
a processor-based device operative to identify a plurality of words contained within the communication, and to process the plurality of words utilizing a joint classifier configured to determine at least one category for the plurality of words based on application of a combination of word information and word class information to the plurality of words.

16. The apparatus of claim 15 wherein the processor-based device comprises a switch of the communication system.

17. The apparatus of claim 15 wherein the processor-based device comprises a processor coupled to a memory.

18. An article of manufacture comprising a machine-readable storage medium containing software code for use in processing a communication in a communication system, wherein the software code when executed implements the steps of:
identifying a plurality of words contained within the communication; and
processing the plurality of words utilizing a joint classifier configured to determine at least one category for the plurality of words based on application of a combination of word information and word class information to the plurality of words.
